(19) United States
(12) Patent Application Publication
(10) Pub. No.: US 2008/0074223 A1
(43) Pub. Date: Mar. 27, 2008

(54) REINFORCING OF PERMANENT MAGNET ARRAYS

(76) Inventor: EDWARD M. PRIBONIC, Seal Beach, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/843,520

(22) Filed: Aug. 22, 2007

Related U.S. Application Data
(60) Provisional application No. 60/846,486, filed on Sep. 22, 2006.

(51) Int. Cl. H01F 7/02

(52) U.S. Cl. 335/306

(57) ABSTRACT

A reinforced permanent magnet array includes a plurality of permanent magnets with each magnet being unnaturally aligned with an adjacent magnet and at least one member at least partially embedded in the magnets for resisting a natural tendency of individual magnets to repulse, twist, and separate from one another.

This invention relates generally to fabricating fixed arrays of permanent magnets to form specific pole alignments. More particularly, the present invention is directed to stabilizing arrays of permanent magnets with minimal loss of magnetic strength and no obstructions to their use. The invention adds significant strength and safety to magnet arrays, and eliminates the potential of array fractures over time as glues and bonding agents age and loose their strength.

Heretofore it has been a common industrial practice to manufacture un-natural magnetic pole alignments for use in research or machinery. Un-natural alignments are those where the pole positions of permanent magnets must be placed by force, as the natural response of the magnets is to realign themselves to attract opposite pole faces together.

The discovery of certain advantages to unnaturally aligning magnet poles has led to the use of several variations of magnet alignment to achieve various magnetic properties. Heretofore, the principal means to prevent such alignments from forcing themselves apart by the inherent forces or magnetic repulsion or magnetic attraction, has been to either glue, (or bond) the magnets into such position, or to force the magnets into a container that will constrain them in the desired positions.

It is common that the gluing or bonding methods have been found to fail frequently as the strength of the magnetic forces is sufficient to overcome the strength of the glues. The result can be violent and almost instantaneous fracturing of the magnet array and instant re-alignment of the individual magnets in North-South face alignment. When powerful magnets are involved, there can be significant dangers involved. Magnet materials, particularly ceramic and NdFeB are brittle and shatter into hundreds of small sharp shards which are sent flying by the force of the fracture and subsequent violent re-alignment. NdFeB often generates sparks during a magnet array fracture. The danger to personnel is significant as the instantaneous re-alignment can capture and crush fingers or limbs between magnets, or between magnets and nearby ferrous objects. Of course, the ensuing destruction of several expensive magnets is also a consideration.

Another common method of constraining magnet arrays is to place the magnets into a container of suitable size and shape. Such containers are typically fabricated from non-magnetic materials of suitable strength to keep the array from re-aligning. Materials commonly used are stainless steel or aluminum, although other materials may be suitable.

The disadvantages of this constraint method are:

1.) The container separates the magnet array from that which it is to communicate, by a distance of at least the thickness of the container wall.

2.) The container must be over sized to allow placement of the array within, and this oversize can allow for fractured magnets to shift or twist, thus reducing the effectiveness of the original alignment.

3.) The fabrication and installation of containers is an additional expense in the manufacture of devices requiring magnetic arrays.

### SUMMARY OF THE INVENTION

A reinforced permanent magnet array in accordance with the present invention generally includes a plurality of permanent magnets with each magnet being unnaturally aligned with the adjacent magnet.

When high strength permanent magnets are forced into polar alignments that are contrary to the natural north-south alignment of all magnets, strong forces are as the magnets seek to find their natural alignment. One array configuration in particular, the Halbach array, is a clear example of such a structure.

Within the Halbach array, magnet poles are aligned at 900 and the array, typically four 5 cubic magnets, experiences attraction, repulsion and torque at various positions along the array. All forces are simultaneously creating force vectors in different directions.

In accordance with the present invention, the addition of non-magnetic reinforcing bars, pins or other components, the array can be stabilized and made stronger and safer to handle.

### BRIEF DESCRIPTION OF THE DRAWINGS

The advantages and features of the present invention will be better understood by the following description when considered in conjunction with the accompanying drawings, in which:

FIG. 1 illustrates a standard Halbach array of four cubic magnets configured by force and held in place by some mechanical means such as for example, glue. The Arrow heads indicate the direction of the North pole on the adjacent vertical face of the cube. It is seen that to configure a Halbach array, the poles of four identical magnets must be arranged at 90° orientations from each other. Since all magnets attract the north and south poles to each other, it is obvious that this arrangement must be constrained in order to maintain the depicted pole orientation;

FIG. 2 illustrates a Halbach array which has been reinforced with non-magnetic, or slightly magnetic bars on the weak faces of the array. The bar resists the natural tendency of the individual magnets to repulse, twist and separate from each other.

FIG. 3 illustrates another embodiment of the present invention in with one or more rods or bars are disposed within the magnet;

FIG. 4 illustrates reinforcing rod groove positions; and

FIG. 5 illustrates alternative reinforcing rod groove positions.

### DETAILED DESCRIPTION

The invention provides a means of constraining unwanted motion or fracturing of permanent magnet arrays which have been glued or bonded into un-natural pole alignments, (other than North-South attraction), particularly Halbach arrays and variations of the Halbach array.

Restraining movement, separation or fracturing of magnet arrays is critical not only for safety during handling, but for continued proper operation of the magnetic device, of which the array may be a component. It is important that when arrays are structured in un-natural pole alignments that close contact and proper positioning be maintained for maximum effect of the alignment. However, minimizing or eliminating any loss of magnetic field strength due to magnet material loss to restraining devices is very advantageous.

The invention can be employed in any number of embodiments depending on the geometry and/or size of the magnets and arrays.

Magnets have two primary poles designated North and South. Magnetic flux is considered to flow circuitously between these two poles within a magnet. It should be noted that in general, the intent of Halbach arrays, Halbach variants and other un-natural pole configurations is to align poles of adjacent magnets in order to redirect flux lines from the magnet, thus encouraging a greater flux density to one side of the magnet array, hereafter defined as the “strong side”. The opposite face of said array will hereafter be defined as the “weak side” of the array.

A preferred embodiment of the invention would place any reinforcing components, devices or shapes on the weak side of an array to prevent any loss of flux due to loss of magnet material volumes displaced by said reinforcing.

Other materials, component shapes, and component sizes than those detailed in the drawings and descriptions of this application may be utilized in the practice of this invention without departing from the scope of the invention.

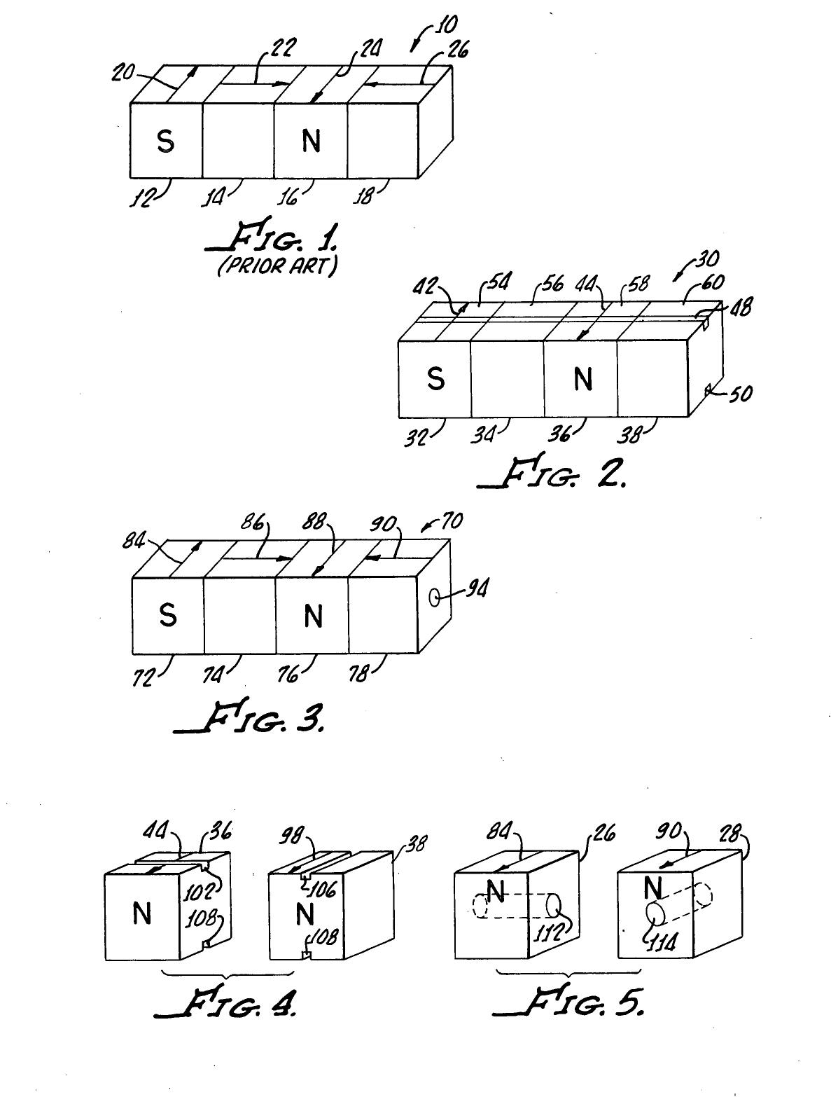

With reference now to FIG. 1, there is shown a standard Halbach array 10 of magnets 12, 14, 16, 18 held together by an adhesive with the like with each magnet 12, 14, 16, 18 being unnaturally aligned with an adjacent magnet 12, 14, 16, 18 as indicated by arrows 20, 22, 24, 26 which indicate the direction of the north pole of each magnet 12, 14, 16, 18. In a conventional Halbach array 10 the poles of the magnets 12, 14, 16, 18 are arranged at 90° orientations from one another.

As hereinabove noted, this array 10 of magnets 12, 14, 16, 18 may separate due to failure of the bond therebetween.

This problem is solved by the reinforced permanent magnet array 30 in accordance with the present invention as illustrated into FIG. 2. This array 30 includes a plurality of permanent magnets 32, 34, 36, 38 unnaturally aligned with north poles being indicated by arrows 42, 44. While shown abutting one another, the magnets 32, 34, 36, 38 may be separated by spacers depending upon the application of the magnet array. Members 48, 50, which may be rods or bars of any suitable cross section are embedded in the surfaces 56, 58, 60 of the magnets 32, 34, 36, 38 on weak side of the magnets 32, 34, 36, 38 as illustrated, strong sides of the magnets being indicated by the letters S and N. Preferably, the members 3542 48, 50 are non-magnetic and, as shown, member 48 may be flush with the surface 54, 56, 58, 60 of the magnets 32, 34, 36, 38 or protrude therefrom.

Thus, the members 48, 50 reinforce the permanent magnet array 30 and prevent separation thereof.

An alternate magnetic array embodiment 70, as illustrated in FIG. 3, including magnet 72, 74, 76, 78 disposed with Halbach orientation, as indicated by arrows 84, 86, 88, 90. In this embodiment 70, a reinforcing rod, or member, 94 is embedded in the magnet 72, 74, 76, 78 in a centered location. It should be appreciated that multiple members (not shown) may be embedded in the array 70 of magnets 72, 74, 76, 78 in a symmetrical or asymmetrical pattern within the magnets 72, 74, 76, 78.

FIG. 4 illustrates individual magnets 36, 38 with arrows 44, 98 indicating north pole orientation and also grooves 102, 104, 106, 108 for accepting the members 48, 50 which may be fixed therein by press fitting or adhesive.

FIG. 5 illustrates individual magnets 76, 78 with bores 112, 114 for receiving the rod, or member, 94.

Although there has been hereinabove described a specific reinforcing of permanent magnet arrays in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A reinforced permanent magnet array comprising:
a plurality of permanent magnets, each magnet being unnaturally aligned with an adjacent magnet;
at least one member at least partially embedded in the magnet for resisting a natural tendency of individual magnets to repulse, twist, and separate from one another.

2. The array according to claim 1 wherein the individual magnet abut one another.

3. The array according to claim 1 wherein the unnatural alignment is a Halback alignment.

4. The array according to claim 1 wherein the member is embedded in a weak side of the magnets.

5. The array according to claim 1 wherein the member comprises a bar.

6. The array according to claim 1 wherein the member is non magnetic.

7. The array according to claim 1 wherein the member is embedded in surfaces of the magnets.

8. The array according to claim 7 wherein the member and surface are flush with one another.

9. The array according to claim 1 wherein the member is embedded within the magnets.

10. The array according to claim 9 wherein the member is a rod.

11. A reinforced permanent magnet array comprising:
a plurality of permanent magnets, each magnet being unnaturally aligned with an adjacent magnet; and
two members, each member being at least partially embedded on an opposing side of the magnets for resisting a natural tendency of individual magnets to repulse, twist, and separate from one another.

12. The array according to claim 11 wherein the individual magnet abut one another.

13. The array according to claim 11 wherein the unnatural alignment is a Halback alignment.

14. The array according to claim 11 wherein the members are embedded in a weak sides of the magnets.

15. The array according to claim 11 wherein the members comprises bars.

16. The array according to claim 11 wherein the members are non magnetic.

17. The array according to claim 11 wherein the members are embedded in surfaces of the magnets.

18. The array according to claim 17 wherein the members and surfaces are flush with one another.

19. The array according to claim 11 wherein the members are embedded within the magnets.

20. The array according to claim 19 wherein the member are rods.
